(19) United States
(12) Patent Application Publication
(10) Pub. No.: US 2025/0334940 A1
(43) Pub. Date: Oct. 30, 2025

(54) EVENT SYSTEM, STORAGE MEDIUM, AND FABRIC

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 19/095,097

(22) Filed: Mar. 31, 2025

(30) Foreign Application Priority Data
Apr. 30, 2024 (JP) 2024-073637

(51) Int. Cl. G05B 15/02; A41B 1/08; A63B 71/06; G01N 27/22; G06F 3/044

(52) U.S. Cl. CPC G05B 15/02; A41B 1/08; G01N 27/228; G06F 3/044; A63B 71/0669; G06F 2203/04102

(57) ABSTRACT

To facilitate recognition of a degree of support for a support target. An event system includes: a control device configured to control venue equipment of an event venue; a capacitive sensor configured to detect a change in capacitance between conductive threads sewn into a fabric; and a terminal device configured to transmit, to the control device, an output signal outputted from the capacitive sensor or a control signal generated based on the output signal, the control device changing, based on the output signal or the control signal, a state of the venue equipment.

This Nonprovisional application claims priority under 35 U.S.C. § 119 on Patent Application No. 2024-073637 filed in Japan on Apr. 30, 2024, the entire contents of which are hereby incorporated by reference.

### TECHNICAL FIELD

The present disclosure relates to an event system, a storage medium, and a fabric.

### BACKGROUND ART

For example, Patent Literature 1 discloses an information processing device that enables an audience of a game to proactively affect how the game unfolds, by providing support.

### CITATION LIST

### Patent Literature

### [Patent Literature 1]

Japanese Patent Application Publication Tokukai No. 2023-155358

### SUMMARY OF INVENTION

### Technical Problem

For example, in a case of watching a sport game, audiences support athletes or target teams, for example, through vocal cheering. However, in crowds of audiences, it may be unclear the support is directed to which athlete or which target team.

It is an object of an aspect of the present disclosure to facilitate recognition of a degree of support for a support target.

### Solution to Problem

In order to attain the foregoing object, an event system in accordance with an aspect of the present disclosure includes: a control device configured to control venue equipment of an event venue; a capacitive sensor configured to detect a change in capacitance between conductive threads sewn into a fabric; and a terminal device configured to transmit, to the control device, an output signal outputted from the capacitive sensor or a control signal generated based on the output signal, the control device changing, based on the output signal or the control signal, a state of the venue equipment.

In order to attain the foregoing object, a computer-readable storage medium in accordance with an aspect of the present disclosure is a computer-readable storage medium storing an application program for causing a computer of a terminal device to function, the application program causing the computer to carry out: a reception process of receiving an output signal outputted from a capacitive sensor configured to detect a change in capacitance between conductive threads sewn into a fabric; and a transmission process of transmitting the output signal or a control signal generated based on the output signal, to a control device configured to change, based on the output signal or the control signal, a state of venue equipment of an event venue.

In order to attain the foregoing object, a fabric in accordance with an aspect of the present disclosure is a fabric into which conductive threads are sewn, wherein an area into which the conductive threads are sewn functions as a capacitive sensor configured to detect a change in capacitance between the conductive threads, and the capacitive sensor is connectable to a terminal device configured to transmit an output signal outputted from the capacitive sensor or a control signal generated based on the output signal, to a control device configured to change, based on the output signal or the control signal, a state of venue equipment of an event venue.

### Advantageous Effects of Invention

According to an aspect of the present disclosure, it is possible to facilitate recognition of a degree of support for a support target.

### BRIEF DESCRIPTION OF DRAWINGS

FIG. 1 is a view illustrating a schematic configuration of one example of an event system in accordance with an embodiment of the present disclosure.

FIG. 2 is a block diagram illustrating an internal configuration of components included in the event system.

FIG. 3 is a sequence diagram illustrating a flow of a process carried out by an event system in accordance with the present disclosure.

FIG. 4 is a view illustrating one example of an image displayed on a display.

### DESCRIPTION OF EMBODIMENTS

### Embodiments

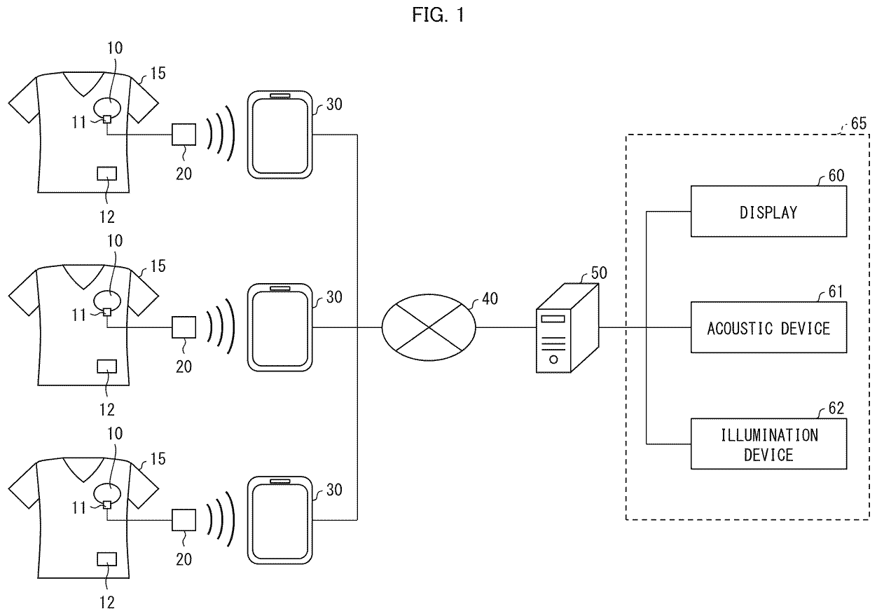

With reference to FIG. 1, the following description will discuss a schematic configuration of an event system 100 in accordance with an embodiment of the present disclosure. FIG. 1 is a view illustrating a schematic configuration of one example of an event system 100 in accordance with an embodiment of the present disclosure.

The event system 100 is a system used for an event that many people join. Examples of the event that many people join include events for sport, music, eating/drinking, charity, election speech, family, and the like. Examples of an event venue may include stadiums, arenas, parks, commercial facilities, and schools. Event participants joining the event are not limited to those visiting the event venue, but may be those watching TV or those using streaming services, for example, via the Internet.

The following description will take, as an example, a sport performed in a stadium 65, as an event in which the event system 100 is used. The event system 100 includes one or more sensors 10, one or more terminal devices 30, and a control device 50.

The event system 100 includes the one or more sensors 10. Each of the sensors 10 is a capacitive sensor configured to detect a change in capacitance between conductive threads sewn into a fabric. Note that the event system 100 preferably includes a plurality of sensors 10, as in the present embodiment.

For example, the sensors 10 are each sewn into part of a uniform 15 worn by an event participant. The event participant presses the sensor 10, for example, by hand, for showing support for a support target team or athlete. That is, the event participant touches an area into which conductive threads are woven in the uniform 15, so that the sensor 10 detects a change in capacitance between the conductive threads. The sensor 10 may detect a change in the pressure applied to an area into which the conductive threads are sewn, on the basis of the change in capacitance between the conductive threads.

The sensor 10 is not limited to the configuration of being sewn into the clothes worn by the event participant. The sensor 10 may be sewn into a fabric attachable to the clothes worn by the event participant. For example, the sensor 10 may be sewn into a patch or badge attachable to the clothes. The sensor 10 may be sewn into, for example, a property carried by the event participant, such as a bag or into, for example, an accessory worn by the event participant, such as an armband.

The sensor 10 is connectable to a terminal device 30 carried by an event participant wearing the uniform 15. The sensor 10 includes a connection terminal 11 for connecting a transmitter 20 in a wired manner. Connection of the transmitter 20 to the sensor 10 allows the terminal device 30 carried by the event participant and the sensor 10 to be communicably connected.

The uniform 15 may be provided with a code 12 in which information for connection between the terminal device 30 and the control device 50 is encoded. In the code 12, for example, information for activating an application of the terminal device 30 or may include a URL or the like for connection to the control device 50 may be encoded. The code 12 is, for example, a two-dimensional code. The code 12 may be formed by being sewed into a fabric as a two-dimensional cord or may be printed on the uniform 15 as a two-dimensional code. Alternatively, the code 12 may be attached to a tag of the uniform 15. Provision of the code 12 to the uniform 15 enables the event system 100 to be easily used. Note that the code 12 may be a one-dimensional code or may be an address indicating a connection destination for the control device 50.

The transmitter 20 transmits, to the terminal device 30, an output signal outputted from the sensor 10. The transmitter 20 is a short-range wireless communication module. The transmitter 20 is, for example, a communication module compliant with the Bluetooth (registered trademark) standard.

The terminal devices 30 are terminals carried by event participants. Examples of the terminal device 30 include a smartphone, a tablet terminal, and a personal computer. The terminal devices 30 are connected to the control device 50 via a network 40. The terminal devices 30 correspond respectively to the plurality of sensors 10 included in the event system 100. The terminal devices 30 each transmit, to the control device 50, a control signal generated on the basis of an output signal from the corresponding one of the sensors 10.

The event participants each activate an application of his/her terminal device 30. For example, the event participant selects a support target team and/or athlete on the application of the terminal device 30. Thereafter, during a game, the event participant presses the sensor 10 sewn into the uniform 15 to support the support target team and/or athlete. The terminal device 30 transmits, to the control device 50, an output signal outputted from the sensor 10 together with information on the support target team and/or athlete selected on the application. Thus, the activation of the application of the terminal device 30 enables the event participant to easily use the event system 100.

The control device 50 controls venue equipment installed in the stadium 65. Examples of a device usable as the control device 50 that changes a state of the equipment of the stadium 65 on the basis of a control signal received from a terminal device 30 include a workstation constituting a cloud server. In the present embodiment, the control device 50 controls a display 60, an acoustic device 61, and an illumination device 62 that are installed in the stadium 65. Note that the control device 50 may be a computer installed in the stadium 65.

The display 60, the acoustic device 61, and the illumination device 62 are each venue equipment installed in the stadium 65 in which a sport game is held. The display 60 displays various images on the basis of an image signal transmitted from the control device 50. The acoustic device 61 outputs a sound on the basis of an acoustic signal transmitted from the control device 50. Examples of the acoustic device 61 include speakers. The illumination device 62 is a device for illuminating an inside of the stadium 65.

### (Internal Configuration of Event System)

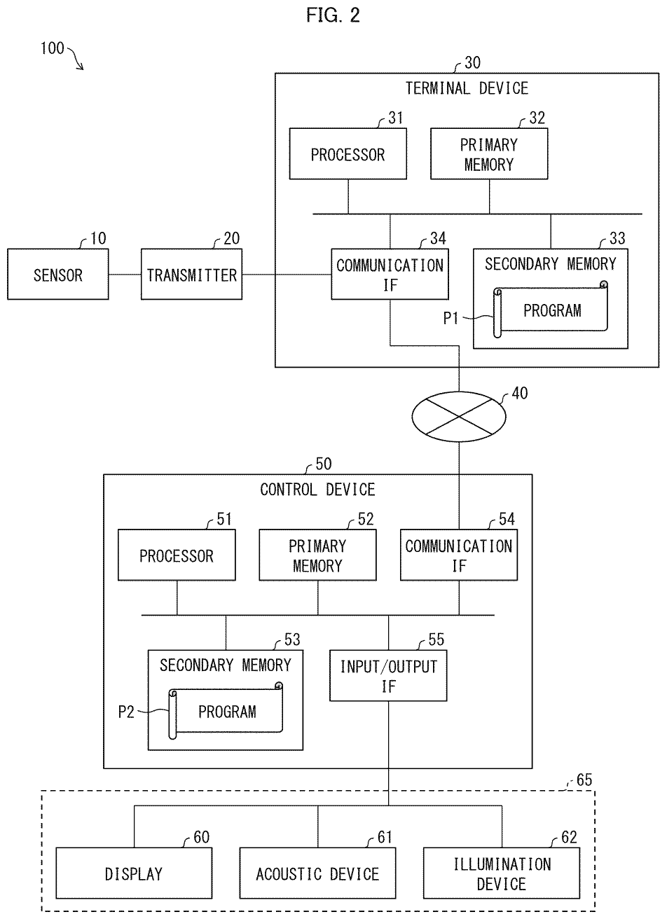

Now turning to FIG. 2, the following description will discuss an internal configuration of components included in the event system 100. FIG. 2 is a block diagram illustrating an internal configuration of components included in the event system 100.

Each of the terminal devices 30 includes a processor 31, a primary memory 32, a secondary memory 33, and a communication IF 34. The processor 31, the primary memory 32, the secondary memory 33, and the communication IF 34 are connected to each other via a bus.

The secondary memory 33 stores a program P1. The program P1 is an application program for causing a computer of the terminal device 30 to function. The terminal device 30 carries out the processes described later in accordance with the program P1. The processor 31 loads the program P1 stored in the secondary memory 33, on the primary memory 32 in accordance with the system program including an operating system (OS). The processor 31 then carries out processes included in the control method C1 (described later) in accordance with instructions included in the program P1 loaded on the primary memory 32. Examples of a device usable as the processor 31 include a central processing unit (CPU). Examples of a device usable as the primary memory 32 include a semiconductor random access memory (RAM). Examples of a device usable as the secondary memory 33 include a hard disk drive (HDD).

The communication IF 34 is an interface for communicating with the control device 50 via the network 40. Examples of an interface usable as the communication IF 34 include an Ethernet (registered trademark) interface. Examples of the network 40 which can be used include a personal area network (PAN), a local area network (LAN), a campus area network (CAN), a metropolitan area network (MAN), a wide area network (WAN), a global area network (GAN), and an internetwork containing a combination thereof. The internetwork may be an intranet, or may be an extranet, or may be the Internet.

The control device 50 includes a processor 51, a primary memory 52, a secondary memory 53, a communication IF 54, and an input/output IF 55. The processor 51, the primary memory 52, the secondary memory 53, the communication IF 54, and the input/output IF 55 are connected to each other via a bus. The processor 51, the primary memory 52, the secondary memory 53, and the communication IF 54 have similar configurations as those of the processor 31, the primary memory 32, the secondary memory 33, and the communication IF 34 described above, respectively.

The secondary memory 53 stores a program P2. The processor 51 controls the display 60, the acoustic device 61, and the illumination device 62 in accordance with instructions included in the program P2.

The input/output IF 55 is an interface for communicating with the venue equipment installed in an event venue. Examples of the input/output IF 55 include interfaces such as a universal serial bus (USB), an advanced technology attachment (ATA), a small computer system interface (SCSI), a High-Definition Multimedia Interface (HDMI) (registered trademark), and serial communication. In the present embodiment, the control device 50 is connected to the display 60, the acoustic device 61, and the illumination device 62 via the input/output IF 55.

### (Process Carried Out by Event System)

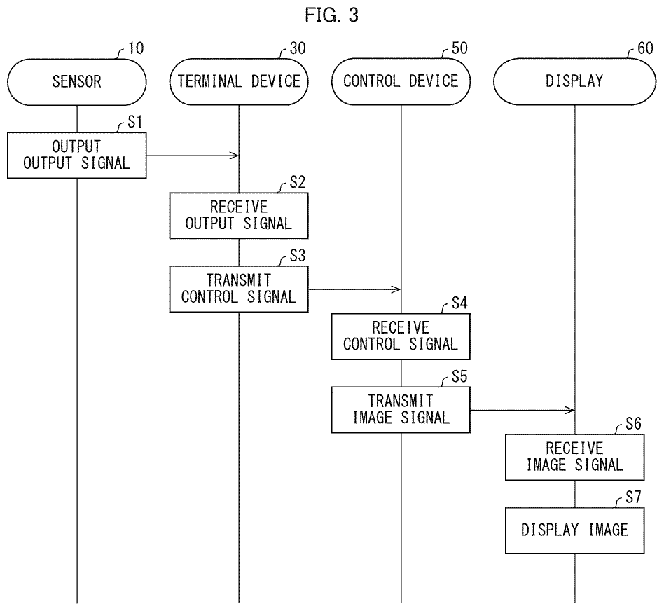

Now turning to FIG. 3, the following description will discuss a process carried out by the event system 100 in accordance with the present disclosure. FIG. 3 is a sequence diagram illustrating a flow of a process carried out by the event system 100. FIG. 3 illustrates a sequence in a case where the control device 50 controls the display 60. Note that when the control device 50 controls the acoustic device 61 and the illumination device 62, similar processes to processes carried out in the case where the control device 50 controls the display 60 are carried out.

As illustrated in FIG. 3, in the step S1, a sensor 10 outputs, in a case where detecting a change in capacitance between the conductive threads, an output signal to the terminal device 30.

In the step S2, the processor 31 receives the output signal outputted from the sensor 10 via the communication IF 34. The step S2 is one example of a reception process in the claims. In the step S3, the processor 31 transmits, to the control device 50, a control signal generated on the basis of the received output signal from the sensor 10, via the communication IF 34. The step S3 is one example of a transmission process in the claims. In the step S3, the processor 31 may transmit, to the control device 50, a control signal generated on the basis of the number of times in which the sensor 10 is pressed and/or the pressure at which the sensor 10 is pressed.

In the step S4, the processor 51 receives the control signal transmitted from the terminal device 30, via the communication IF 54. In the step S5, the processor 51 transmits, to the display 60, an image signal generated on the basis of the control signal transmitted from the terminal device 30, via the input/output IF 55.

In the step S6, the display 60 receives an image signal transmitted from the control device 50. In the step S7, the display 60 displays an image on the basis of the image signal received.

### (Image Example)

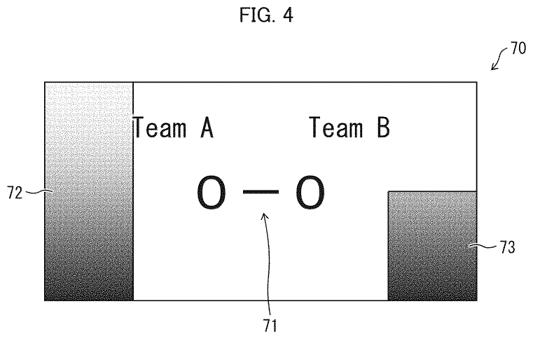

With reference to FIG. 4, the following description will discuss an image example displayed on the display 60 on the basis of the image signal transmitted from the control device 50. FIG. 4 is a view illustrating one example of an image displayed on the display 60.

The display 60 displays a status displaying screen 70 displaying a game status of the sport. The status displaying screen 70 includes, for example, progress information 71 and support information 72, 73. The progress information 71 is information indicating game progress of the sport. For example, as illustrated in FIG. 4, the progress information 71 displays the score of Team A and the score of Team B.

The support information 72, 73 is an indication showing a degree of support indicated by the event participants pressing the sensors 10 thereof. The support information 72 is an indication showing a degree of support for Team A, and the support information 73 is an indication showing a degree of support for Team B.

The support information 72, 73 is displayed as, for example, an indicator showing a degree of support. The support information 72 is displayed on a Team A side of the status displaying screen 70. In the present embodiment, the support information 72 is displayed on a left side of the status displaying screen 70. The support information 73 is displayed on a Team B side of the status displaying screen 70. In the present embodiment, the support information 73 is displayed on a right side of the status displaying screen 70.

In the support information 72, 73, for example, the more the number of times in which the event participants press the sensors 10 thereof is, the more the indicator rises. That is, the display state of the display 60 changes. In the support information 72, 73, for example, the stronger pressures at which the event participants press the sensors 10 thereof are, the more the indicator rises. The support information 72, 73 may be displayed as an indicator showing a ratio of a degree of support for each of Team A and Team B relative to the entire degree of support including the support for Team A and the support for Team B.

Note that the support information 72, 73 is not limited to an indication using an indicator. For example, a background color of the status displaying screen 70 may be a color representing a team that has a higher degree of support. The support information 72, 73 is not limited to being displayed on the status displaying screen 70. For example, a dedicated screen for displaying the support information 72, 73 may be displayed on the display 60.

The support information 72, 73 shows a degree of support for each of the support target teams, but is not limited to this configuration. The support information 72, 73 may show a degree of support for an athlete belonging to each of the support target teams. For example, the support information 72, 73 each may be an indication showing a degree of support for one athlete picked up from among the athletes belonging to each team. The support information 72, 73 each may be an indication showing a degree of support for each of the athletes of each team who participate in a game. In this case, each support information 72, 73 includes, for example, a plurality of indicators showing degrees of support for the respective athletes.

The control device 50 may, in a case where controlling the acoustic device 61, change an acoustic state of the acoustic device 61 on the basis of the control signal transmitted from each of the terminal devices 30. Specifically, the control device 50 may change, for example, a volume or the type of the sound outputted from the acoustic device 61, on the basis of the control signal from each of the terminal devices 30. For example, in a case where a degree of support is high, a volume of the sound outputted from the acoustic device 61 may be increased, and in a case where a degree of support is low, a volume of the sound outputted from the acoustic device 61 may be diminished. For example, in a case where the degree of support for Team A is higher than that for Team B, a team song or music for supporting Team A may be outputted from the acoustic device 61.

The control device 50 may, in a case where controlling the illumination device 62, change an illumination state of the illumination device 62 on the basis of the control signal transmitted from each of the terminal devices 30. Specifically, the control device 50 may change the brightness of illumination of the illumination device 62 and/or the color of the illumination on the basis of the control signal from each of the terminal devices 30. For example, in a case where a degree of support is high, illumination of the illumination device 62 may be made brighter, and in a case where a degree of support is low, illumination of the illumination device 62 may be made dimmer. For example, in a case where the degree of support for Team A is higher than that for Team B, the color of illumination of the illumination device 62 may be set to a color representing Team A.

According to the event system 100, the event participants press the sensors 10 sewn into their uniforms 15, so that degrees of support of the event participants are reflected to the venue equipment of the stadium 65. This makes it possible to facilitate recognition of a degree of support for a support target team and/or athlete.

The control device 50 controls the display 60, the acoustic device 61, and the illumination device 62, so that it is possible to visually or audibly recognize a degree of support of the event participant.

The sensor 10 using conductive threads is sewn into the uniform 15, so that it is possible to wash the uniform 15. Further, there is no need for an event participant to point the line of sight toward the terminal device 30 in order to operate the terminal device 30. This allows the event participant to provide support without diverting the line of sight from the game.

### OTHER EMBODIMENTS

In the above embodiment, the terminal devices 30 are each configured to transmit a control signal to the control device 50, but are not limited to this configuration. The terminal device 30 may be configured to transmit an output signal from the sensor 10, to the control device 50. That is, the terminal device 30 does not generate a control signal after receiving the output signal outputted from the sensor 10. In this case, the control device 50 may generate control signals for changing states of the display 60, the acoustic device 61, and the illumination device 62 on the basis of an output signal from the sensor 10 which has been received from the terminal device 30.

In the above embodiment, the control device 50 is configured to control the display 60, the acoustic device 61, and the illumination device 62, but is not limited to this configuration. The control device 50 only needs to be one that controls venue equipment for event effects which is installed in the event venue. For example, the control device 50 may control a smoke emitting device that emits smoke, a pyrotechnic device that launches a firework, or a launching device that launches balloons, confetti, or paper tapes, for event effects.

Aspects of the present invention can also be expressed as follows.

An event system in accordance with Aspect 1 of the present invention includes: a control device configured to control venue equipment of an event venue; a capacitive sensor configured to detect a change in sewn into a capacitance between conductive threads fabric; and a terminal device configured to transmit, to the control device, an output signal outputted from the capacitive sensor or a control signal generated based on the output signal, the control device changing, based on the output signal or the control signal, a state of the venue equipment.

According to the event system in accordance with Aspect 1, an event participant presses the capacitive sensor sewn into a fabric, so that a degree of support of the event participant is reflected to the venue equipment of the event venue. This makes it possible to facilitate recognition of a degree of support for a support target.

In an event system in accordance with Aspect 2 of the present invention, in Aspect 1 above, the control device may control at least one of a display, an acoustic device, and an illumination device that are installed in the event venue. According to the event system in accordance with Aspect 2, it is possible to visually or audibly recognize a degree of support of the event participant.

A computer-readable storage medium in accordance with Aspect 3 of the present invention is a computer-readable storage medium storing an application program for causing a computer of a terminal device to function, the application program causing the computer to carry out: a reception process of receiving an output signal outputted from a capacitive sensor configured to detect a change in capacitance between conductive threads sewn into a fabric; and a transmission process of transmitting the output signal or a control signal generated based on the output signal, to a control device configured to change, based on the output signal or the control signal, a state of venue equipment of an event venue. The application program in accordance with Aspect 3 enables the event participant to easily use the event system.

A fabric in accordance with Aspect 4 of the present invention is a fabric into which conductive threads are sewn, wherein an area into which the conductive threads are sewn functions as a capacitive sensor configured to detect a change in capacitance between the conductive threads, and the capacitive sensor is connectable to a terminal device configured to transmit an output signal outputted from the capacitive sensor or a control signal generated based on the output signal, to a control device configured to change, based on the output signal or the control signal, a state of venue equipment of an event venue. The fabric in accordance with Aspect 4 enables the fabric to be washed.

To a fabric in accordance with Aspect 5 of the present invention, in Aspect 4, a code in which information for connection between the terminal device and the control device is encoded may be attached. The fabric in accordance with Aspect 5 enables an event system to be easily used.

### SUPPLEMENTARY NOTE

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

1. An event system comprising:
a control device configured to control venue equipment of an event venue;
a capacitive sensor configured to detect a change in capacitance between conductive threads sewn into a fabric; and
a terminal device configured to transmit, to the control device, an output signal outputted from the capacitive sensor or a control signal generated based on the output signal,
the control device changing, based on the output signal or the control signal, a state of the venue equipment.

2. The event system according to claim 1, wherein the control device controls at least one of a display, an acoustic device, and an illumination device that are installed in the event venue.

3. A computer-readable storage medium storing an application program for causing a computer of a terminal device to function, the application program causing the computer to carry out:
a reception process of receiving an output signal outputted from a capacitive sensor configured to detect a change in capacitance between conductive threads sewn into a fabric; and
a transmission process of transmitting the output signal or a control signal generated based on the output signal, to a control device configured to change, based on the output signal or the control signal, a state of venue equipment of an event venue.

4. A fabric into which conductive threads are sewn, wherein
an area into which the conductive threads are sewn functions as a capacitive sensor configured to detect a change in capacitance between the conductive threads, and
the capacitive sensor is connectable to a terminal device configured to transmit an output signal outputted from the capacitive sensor or a control signal generated based on the output signal, to a control device configured to change, based on the output signal or the control signal, a state of venue equipment of an event venue.

5. The fabric according to claim 4, to which a code in which information for connection between the terminal device and the control device is encoded is attached.
